(19) United States
(12) Patent Application Publication
(10) Pub. No.: US 2007/0003869 A1
(43) Pub. Date: Jan. 4, 2007

(54) Heat-sensitive lithographic printing plate-precursor

(75) Inventors: Hubertus Van Aert, Pulderbos (BE); Stefaan Lingier, Assenede (BE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: AGFA-GEVAERT, Mortsel (BE)

(21) Appl. No.: 11/473,414

(22) Filed: Jun. 23, 2006

Related U.S. Application Data
(60) Provisional application No. 60/700,133, filed on Jul. 18, 2005.

(30) Foreign Application Priority Data
Jun. 30, 2005 (EP) 05105880.8

(51) Int. Cl. G03C 1/00

(52) U.S. Cl. 430/270.1

(57) ABSTRACT

A heat-sensitive lithographic printing plate precursor is disclosed which comprises a support having a hydrophilic surface and a coating which does not dissolve in an aqueous alkaline developer in the unexposed areas and which becomes soluble in an aqueous alkaline developer in the exposed areas, wherein said coating comprises a polymer having a first monomeric unit of formula I 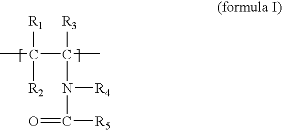 wherein
R₁, R₂ and R₃ are independently a hydrogen atom or an optionally substituted alkyl group,
R₄ and R₅ are independently an optionally substituted alkyl, cycloalkyl, aryl or arylalkyl group. The precursor exhibits an excellent differentiation in dissolution kinetics between the exposed and non-exposed areas of the coating and a high chemical resistance against printing liquids and press chemicals.

### CROSS-REFERENCE TO RELATED PATENT APPLICATIONS

This application claims the benefit of U.S. Provisional Application No. 60/700,133 filed Jul. 18, 2005, which is incorporated by reference. In addition, this application claims the benefit of European Application No. 05105880.8 filed Jun. 30, 2005, which is also incorporated by reference.

### DESCRIPTION

1. Field of the Invention

The present invention relates to a heat-sensitive lithographic printing plate precursor.

2. Background of the Invention

Lithographic printing typically involves the use of a so-called printing master such as a printing plate which is mounted on a cylinder of a rotary printing press. The master carries a lithographic image on its surface and a print is obtained by applying ink to said image and then transferring the ink from the master onto a receiver material, which is typically paper. In conventional lithographic printing, ink as well as an aqueous fountain solution (also called dampening liquid) are supplied to the lithographic image which consists of oleophilic (or hydrophobic, i.e. ink-accepting, water-repelling) areas as well as hydrophilic (or oleophobic, i.e. water-accepting, ink-repelling) areas. In so-called driographic printing, the lithographic image consists of ink-accepting and ink-abhesive (ink-repelling) areas and during driographic printing, only ink is supplied to the master.

Printing masters are generally obtained by the image-wise exposure and processing of an imaging material called plate precursor. A typical positive-working plate precursor comprises a hydrophilic support and an oleophilic coating which is not readily soluble in an aqueous alkaline developer in the non-exposed state and becomes soluble in the developer after exposure to radiation. In addition to the well known photosensitive imaging materials which are suitable for UV contact exposure through a film mask (the so-called pre-sensitized plates), also heat-sensitive printing plate precursors have become very popular. Such thermal materials offer the advantage of daylight stability and are especially used in the so-called computer-to-plate method (CtP) wherein the plate precursor is directly exposed, i.e. without the use of a film mask. The material is exposed to heat or to infrared light and the generated heat triggers a (physico-)chemical process, such as ablation, polymerization, insolubilization by cross-linking of a polymer or by particle coagulation of a thermoplastic polymer latex, and solubilization by the destruction of intermolecular interactions or by increasing the penetrability of a development barrier layer.

Although some of these thermal processes enable plate making without wet processing, the most popular thermal plates form an image by a heat-induced solubility difference in an alkaline developer between exposed and non-exposed areas of the coating. The coating typically comprises an oleophilic binder, e.g. a phenolic resin, of which the rate of dissolution in the developer is either reduced (negative working) or increased (positive working) by the image-wise exposure. During processing, the solubility differential leads to the removal of the non-image (non-printing) areas of the coating, thereby revealing the hydrophilic support, while the image (printing) areas of the coating remain on the support.

Typically, for a positive-working thermal plate, a dissolution inhibitor is added to a phenolic resin as binder whereby the rate of dissolution of the coating is reduced. Upon heating, this reduced rate of dissolution of the coating is increased on the exposed areas compared with the non-exposed areas, resulting in a sufficient difference in solubility of the coating after image-wise recording by heat or IR-radiation. Many different dissolution inhibitors are known and disclosed in the literature, such as organic compounds having an aromatic group and a hydrogen bonding site or polymers or surfactants comprising siloxane or fluoroalkyl units.

The known heat-sensitive printing plate precursors typically comprise a hydrophilic support and a coating which is alkali-soluble in exposed areas (positive working material) or in non-exposed areas (negative working material) and an IR-absorbing compound. Such coating typically comprises an oleophilic polymer which may be a phenolic resin such as novolac, resol or a polyvinylphenolic resin. The phenolic resin can be chemically modified whereby the phenolic monomeric unit is substituted by a group such as described in WO99/01795, EP 934 822, EP 1 072 432, U.S. Pat. No. 3,929,488, EP 2 102 443, EP 2 102 444, EP 2 102 445, EP 2 102 446. The phenolic resin can also be mixed with another polymer such as an acidic polyvinyl acetal as described in WO2004/020484 or a copolymer comprising sulfonamide groups as described in U.S. Pat. No. 6,143,464. The use of other polymeric binders in lithographic printing plates are described in WO2001/09682, EP 933 682, WO99/63407, WO2002/53-626, EP 1 433 594 and EP 1 439 058.

EP 731 113 discloses a light sensitive material for a lithographic printing plate. The material comprises 1,2-quinone-diazide and a polymeric binder such as a copolymer comprising N-methacryloylaminomethyl-phthalimide as monomeric unit.

### SUMMARY OF THE INVENTION

The printing plate precursor of the present invention is positive-working, i.e. after exposure and development the exposed areas of the oleophilic coating, hereinafter also referred to as “heat-sensitive coating” or “coating”, are removed from the support and define hydrophilic, non-image (non-printing) areas, whereas the unexposed coating is not removed from the support and defines an oleophilic image (printing) area. The polymers of the prior art are not suited for use in the heat-sensitive coating because an insufficient differentiation in dissolution kinetics between the exposed and non-exposed areas upon heating was obtained. Therefore, the inventors found a new polymeric binder for the heat-sensitive coating which is able to exhibit an excellent differentiation in dissolution kinetics between the exposed and non-exposed areas of the coating and which has also the advantage of a high chemical resistance of the coating, i.e. the resistance of the coating against printing liquids such as ink, e.g. UV-inks, fountain solution, plate and blanket cleaners.

It is an aspect of the present invention to provide a heat-sensitive lithographic printing plate precursor as defined in claim 1, having the characteristic feature the polymer in the heat-sensitive coating of the precursor comprises a first monomeric unit of formula I 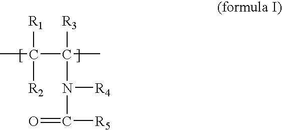
wherein
R₁, R₂ and R₃ are independently a hydrogen atom or an optionally substituted alkyl group,
R₄ and R₅ are independently an optionally substituted alkyl, cycloalkyl, aryl or arylalkyl group, or wherein R₄ and R₅ together form a cyclic structure, and
wherein said polymer comprises said first monomeric unit in an amount between 3 mol % and 75 mol %.

Specific embodiments of the invention are defined in the dependent claims.

### DETAILED DESCRIPTION OF THE INVENTION

In accordance with the present invention, there is provided a heat-sensitive lithographic printing plate precursor comprising a support having a hydrophilic surface or which is provided with a hydrophilic layer, and a coating which does not dissolve in an aqueous alkaline developer in the exposed areas and which becomes soluble in an aqueous alkaline developer in the exposed areas, characterised in that said coating comprises a polymer having a first monomeric unit of formula I 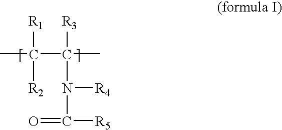
wherein
R₁, R₂ and R₃ are independently a hydrogen atom or an optionally substituted alkyl group,
R₄ and R₅ are independently an optionally substituted alkyl, cycloalkyl, aryl or arylalkyl group, or wherein R₄ and R₅ together form a cyclic structure, and
wherein said polymer comprises said first monomeric unit in an amount between 3 mol % and 75 mol %.

In a preferred embodiment, R₄ and R₅ together form a cyclic structure comprising at least 5 carbon atoms. In a still more preferred embodiment, the first monomeric unit is vinylcaprolactam. The polymer comprises the first monomeric unit in an amount ranging between 3 and 75 mol %, more preferably between 4 and 60 mol %, most preferably between 5 and 50 mol %.

In another embodiment of the present invention, the polymer further comprises a second monomeric unit of formula II 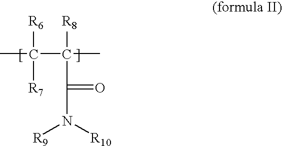
wherein
R₆, R₇ and R₈ are independently a hydrogen atom or an optionally substituted alkyl group,
R₉ is a hydrogen atom, or an optionally substituted alkyl, cycloalkyl, aryl or arylalkyl group,
R₁₀ is represented by formula III or IV: 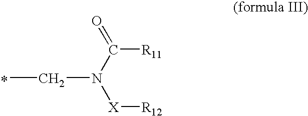 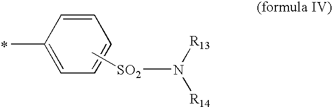
wherein
* denotes the position of attachment of the group R₁₀ to the nitrogen atom in the above formula II,
X is —C(═O)— or —SO₂—,
R₁₁ and R₁₂ are independently an optionally substituted alkyl, alkenyl, cycloalkyl, aryl, arylalkyl or heteroaryl group, or wherein R₁₁ and R₁₂ together form a cyclic structure,
R₁₃ and R₁₄ are independently a hydrogen atom, or an optionally substituted alkyl, alkenyl, cycloalkyl, aryl, arylalkyl or heteroaryl group, or wherein R₁₃ and R₁₄ together form a cyclic structure.

In a preferred embodiment, R₁₀ has the structure of formula V: 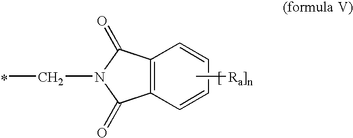
wherein
* denotes the position of attachment of the group R₁₀ to the nitrogen atom in the above formula II,
n is 0, 1, 2, 3 or 4,
each Rₐ is independently selected from hydrogen, halogen, —CN, —NO₂, an optionally substituted alkyl, alkenyl, alkynyl, cycloalkyl, heterocyclic, aryl, heteroaryl, aralkyl or heteroaralkyl group, —O— Rb, —S—R_{c}, —SO₃—Rd, —CO—O—Re, —O—CO—R_{f}, —NR_{g}Rₕ, —NRᵢ—CO—Rⱼ, —NRₖ—SO₂—R₁, —CO—Rₘ, —CO—NRₙRₒ, —SO₂—NRₚR_{q} or —P(═O)(—O—Rᵣ)(—O—Rₛ),
wherein R_{b} to Rₛ are independently selected from hydrogen or an optionally substituted alkyl or aryl group.

The second monomeric unit is preferably N-acryloylaminomethyl-phthalimide or N-methacryloylaminomethyl-phthalimide.

The polymer preferably comprises the second monomeric unit in an amount ranging between 5 and 95 mol %, more preferably between 10 and 85 mol %, most preferably between 20 and 75 mol %.

In another embodiment of the present invention, the polymer further comprises a third monomeric unit of formula VI: 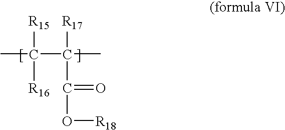
wherein
R₁₅, R₁₆ and R₁₇ are independently a hydrogen atom or an optionally substituted alkyl group,
R₁₈ is a hydrogen atom, a positive charged metal ion or ammonium ion, or an optionally substituted alkyl, cycloalkyl, aryl or arylalkyl group.

In a preferred embodiment, the third monomeric unit is (meth)acrylic acid or salts or alkyl esters thereof.

The polymer preferably comprises the third monomeric unit in an amount ranging between 2 and 70 mol %, more preferably between 4 and 60 mol %, most preferably between 6 and 50 mol %.

In another preferred embodiment of the present invention, the polymer comprises a combination of a first monomeric unit of formula I, a second monomeric unit of formula II and a third monomeric unit of formula VI. The polymer preferably comprises these three monomeric units in an amount ranging between 5 and 50 mol % for the first monomeric unit, between 20 and 75 mol % for the second monomeric unit and between 3 and 40 mol % for the third monomeric unit. In a more preferred embodiment of the present invention, the polymer comprises a combination of N-vinylcaprolactam, N-(meth)acryloylaminomethyl-phthalimide and (meth)acrylic acid. The polymer preferably comprises N-vinylcaprolactam in the in an amount ranging between 5 and 50 mol %, more preferably between 10 and 40 mol %, N-(meth)acryloylamino methyl-phthalimide between 20 and 75 mol %, more preferably between 30 and 70 mol %, (meth)acrylic acid between 3 and 35 mol %, more preferably between 5 and 30 mol %.

Other polymers such as phenolic resins, novolac, resoles, polyvinyl phenol or carboxy-substituted polymers can be added to the heat-sensitive coating. Examples of such polymers are described in DE-A-4007428, DE-A-4027301 and DE-A-4445820. Also phenolic resin wherein the phenyl group or the hydroxy group of the phenolic monomeric unit are chemically modified with an organic substituent as described in EP 894 622, EP 901 902, EP 933 682, WO99/63407, EP 934 822, EP 1 072 432, U.S. Pat. No. 5,641,608, EP 982 123, WO99/01795, WO04/035310, WO04/035686, WO04/035645, WO04/035687 or EP 1 506 858 can be added to the heat-sensitive coating.

In a preferred positive-working lithographic printing plate precursor, the coating also contains one or more dissolution inhibitors. Dissolution inhibitors are compounds which reduce the dissolution rate of the hydrophobic polymer in the aqueous alkaline developer at the non-exposed areas of the coating and wherein this reduction of the dissolution rate is diminished by the heat generated during the exposure so that the coating readily dissolves in the developer at exposed areas. Thereby, the dissolution inhibitor provides a wide differentiation in dissolution rate between the exposed and non-exposed areas. By preference, the coating has a good development latitude, i.e. the exposed coating areas have dissolved completely in the developer before the non-exposed areas are attacked by the developer to such an extent that the ink-accepting capability of the coating is affected. The dissolution inhibitor(s) can be added to the layer which comprises the hydrophobic polymer discussed above.

The dissolution rate of the non-exposed coating in the developer is preferably reduced by interaction between the hydrophobic polymer and the inhibitor, due to e.g. hydrogen bonding between these compounds. Suitable dissolution inhibitors are preferably organic compounds which comprise at least one aromatic group and a hydrogen bonding site, e.g. a carbonyl group, a sulfonyl group, or a nitrogen atom which may be quaternized and which may be part of a heterocyclic ring or which may be part of an amino substituent of said organic compound. Suitable dissolution inhibitors of this type have been disclosed in e.g. EP-A 825 927 and 823 327.

Water-repellent polymers represent an another type of suitable dissolution inhibitors. Such polymers seem to increase the developer resistance of the coating by repelling the aqueous developer from the coating. The water-repellent polymers can be added to the layer comprising the hydrophobic polymer and/or can be present in a separate layer provided on top of the layer with the hydrophobic polymer. In the latter embodiment, the water-repellent polymer forms a barrier layer which shields the coating from the developer and the solubility of the barrier layer in the developer or the penetrability of the barrier layer by the developer can be increased by exposure to heat or infrared light, as described in e.g. EP-A 864420, EP-A 950 517 and WO99/21725. Preferred examples of the water-repellent polymers are polymers comprising siloxane and/or perfluoroalkyl units. In one embodiment, the coating contains such a water-repellent polymer in an amount between 0.5 and 25 mg/m preferably between 0.5 and 15 mg/m and most preferably between 0.5 and 10 mg/m². When the water-repellent polymer is also ink-repelling, e.g. in the case of polysiloxanes, higher amounts than 25 mg/m can result in poor ink-acceptance of the non-exposed areas. An amount lower than 0.5 mg/m on the other hand may lead to an unsatisfactory development resistance. The polysiloxane may be a linear, cyclic or complex cross-linked polymer or copolymer. The term polysiloxane compound shall include any compound which contains more than one siloxane group —Si(R,R′)—O—, wherein R and R′ are optionally substituted alkyl or aryl groups. Preferred siloxanes are phenylalkylsiloxanes and dialkylsiloxanes. The number of siloxane groups in the (co)polymer is at least 2, preferably at least 10, more preferably at least 20. It may be less than 100, preferably less than 60. In another embodiment, the water-repellent polymer is a block-copolymer or a graft-copolymer of a poly(alkylene oxide) block and a block of a polymer comprising siloxane and/or perfluoroalkyl units. A suitable copolymer comprises about 15 to 25 siloxane units and 50 to 70 alkylene oxide groups. Preferred examples include copolymers comprising phenylmethylsiloxane and/or dimethylsiloxane as well as ethylene oxide and/or propylene oxide, such as Tego Glide 410, Tego Wet 265, Tego Protect 5001 or Silikophen P50/X, all commercially available from Tego Chemie, Essen, Germany. Such a copolymer acts as a surfactant which upon coating, due to its bifunctional structure, automatically positions itself at the interface between the coating and air and thereby forms a separate top layer even when the whole coating is applied from a single coating solution. Simultaneously, such surfactants act as a spreading agent which improves the coating quality. Alternatively, the water-repellent polymer can be applied in a second solution, coated on top of the layer comprising the hydrophobic polymer. In that embodiment, it may be advantageous to use a solvent in the second coating solution that is not capable of dissolving the ingredients present in the first layer so that a highly concentrated water-repellent phase is obtained at the top of the coating.

Preferably, also one or more development accelerators are included in the coating, i.e. compounds which act as dissolution promoters because they are capable of increasing the dissolution rate of the non-exposed coating in the developer. The simultaneous application of dissolution inhibitors and accelerators allows a precise fine tuning of the dissolution behavior of the coating. Suitable dissolution accelerators are cyclic acid anhydrides, phenols or organic acids. Examples of the cyclic acid anhydride include phthalic anhydride, tetrahydrophthalic anhydride, hexahydrophthalic anhydride, tetrachlorophthalic anhydride, maleic anhydride, chloromaleic anhydride, alpha-phenylmaleic anhydride, succinic anhydride, and pyromellitic anhydride, as described in U.S. Pat. No. 4,115,128. Examples of the phenols include bisphenol A, p-nitrophenol, p-ethoxyphenol, 2,4,4′-trihydroxybenzophenone, 2,3,4-trihydroxy-benzophenone, 4-hydroxybenzophenone, 4,4′,4″-trihydroxy-triphenylmethane, and 4,4′,3″,4″-tetrahydroxy-3,5,3′,5′-tetramethyltriphenyl-methane, and the like. Examples of the organic acids include sulfonic acids, sulfinic acids, alkylsulfuric acids, phosphonic acids, phosphates, and carboxylic acids, as described in, for example, JP-A Nos. 60-88,942 and 2-96,755. Specific examples of these organic acids include p-toluenesulfonic acid, dodecylbenzenesulfonic acid, p-toluenesulfinic acid, ethylsulfuric acid, phenylphosphonic acid, phenylphosphinic acid, phenyl phosphate, diphenyl phosphate, benzoic acid, isophthalic acid, adipic acid, p-toluic acid, 3,4-dimethoxybenzoic acid, phthalic acid, terephthalic acid, 4-cyclohexene-1,2-dicarboxylic acid, erucic acid, lauric acid, n-undecanoic acid, and ascorbic acid. The amount of the cyclic acid anhydride, phenol, or organic acid contained in the coating is preferably in the range of 0.05 to 20% by weight, relative to the coating as a whole.

The support has a hydrophilic surface or is provided with a hydrophilic layer. The support may be a sheet-like material such as a plate or it may be a cylindrical element such as a sleeve which can be slid around a print cylinder of a printing press. Preferably, the support is a metal support such as aluminum or stainless steel.

A particularly preferred lithographic support is an electrochemically grained and anodized aluminum support.

Graining and anodizing of aluminum lithographic supports is well known. The grained aluminum support used in the material of the present invention is preferably an electrochemically grained support. The acid used for graining can be e.g. nitric acid. The acid used for graining preferably comprises hydrogen chloride. Also mixtures of e.g. hydrogen chloride and acetic acid can be used.

The grained and anodized aluminum support may be post-treated to improve the hydrophilic properties of its surface. For example, the aluminum support may be silicated by treating its surface with a sodium silicate solution at elevated temperature, e.g. 95° C. Alternatively, a phosphate treatment may be applied which involves treating the aluminum oxide surface with a phosphate solution that may further contain an inorganic fluoride. Further, the aluminum oxide surface may be rinsed with an organic acid and/or salt thereof, e.g. carboxylic acids, hydroxycarboxylic acids, sulfonic acids or phosphonic acids, or their salts, e.g. succinates, phosphates, phosphonates, sulfates, and sulfonates. A citric acid or citrate solution is preferred. This treatment may be carried out at room temperature or may be carried out at a slightly elevated temperature of about 30 to 50° C. A further post-treatment involves rinsing the aluminum oxide surface with a bicarbonate solution. Still further, the aluminum oxide surface may be treated with polyvinylphosphonic acid, polyvinylmethylphosphonic acid, phosphoric acid esters of polyvinyl alcohol, polyvinylsulfonic acid, polyvinylbenzenesulfonic acid, sulfuric acid esters of polyvinyl alcohol, and acetals of polyvinyl alcohols formed by reaction with a sulfonated aliphatic aldehyde. It is further evident that one or more of these post-treatments may be carried out alone or in combination. More detailed descriptions of these treatments are given in GB-A-1 084 070, DE-A-4 423 140, DE-A-4 417 907, EP-A-659 909, EP-A-537 633, DE-A-4 001 466, EP-A-292 801, EP-A-291 760 and U.S. Pat. No. 4,458,005.

According to another embodiment, the support can also be a flexible support, which is provided with a hydrophilic layer, hereinafter called ‘base layer’. The flexible support is e.g. paper, plastic film, thin aluminum or a laminate thereof. Preferred examples of plastic film are polyethylene terephthalate film, polyethylene naphthalate film, cellulose acetate film, polystyrene film, polycarbonate film, etc. The plastic film support may be opaque or transparent.

The base layer is preferably a cross-linked hydrophilic layer obtained from a hydrophilic binder cross-linked with a hardening agent such as formaldehyde, glyoxal, polyisocyanate or a hydrolyzed tetra-alkylorthosilicate. The latter is particularly preferred. The thickness of the hydrophilic base layer may vary in the range of 0.2 to 25 μm and is preferably 1 to 10 μm.

The hydrophilic binder for use in the base layer is e.g. a hydrophilic (co)polymer such as homopolymers and copolymers of vinyl alcohol, acrylamide, methylol acrylamide, methylol methacrylamide, acrylic acid, methacrylic acid, hydroxyethyl acrylate, hydroxyethyl methacrylate or maleic anhydride/vinylmethylether copolymers. The hydrophilicity of the (co)polymer or (co)polymer mixture used is preferably the same as or higher than the hydrophilicity of polyvinyl acetate hydrolyzed to at least an extent of 60% by weight, preferably 80% by weight.

The amount of hardening agent, in particular tetraalkyl orthosilicate, is preferably at least 0.2 parts per part by weight of hydrophilic binder, more preferably between 0.5 and 5 parts by weight, most preferably between 1 parts and 3 parts by weight.

The hydrophilic base layer may also contain substances that increase the mechanical strength and the porosity of the layer. For this purpose colloidal silica may be used. The colloidal silica employed may be in the form of any commercially available water dispersion of colloidal silica for example having an average particle size up to 40 nm, e.g. 20 nm. In addition inert particles of larger size than the colloidal silica may be added e.g. silica prepared according to Stöber as described in J. Colloid and Interface Sci., Vol. 26, 1968, pages 62 to 69 or alumina particles or particles having an average diameter of at least 100 nm which are particles of titanium dioxide or other heavy metal oxides. By incorporating these particles the surface of the hydrophilic base layer is given a uniform rough texture consisting of microscopic hills and valleys, which serve as storage places for water in background areas.

Particular examples of suitable hydrophilic base layers for use in accordance with the present invention are disclosed in EP-A-601 240, GB-P-1 419 512, FR-P-2 300 354, U.S. Pat. No. 3,971,660, and U.S. Pat. No. 4,284,705.

It is particularly preferred to use a film support to which an adhesion improving layer, also called support layer, has been provided. Particularly suitable adhesion improving layers for use in accordance with the present invention comprise a hydrophilic binder and colloidal silica as disclosed in EP-A-619 524, EP-A-620 502 and EP-A-619 525. Preferably, the amount of silica in the adhesion improving layer is between 200 mg/m² and 750 mg/m². Further, the ratio of silica to hydrophilic binder is preferably more than 1 and the surface area of the colloidal silica is preferably at least 300 m²/gram, more preferably at least 500 m²/gram.

The coating provided on the support is heat-sensitive and can preferably be handled in normal working lighting conditions (daylight, fluorescent light) for several hours. The coating preferably does not contain UV-sensitive compounds which have an absorption maximum in the wavelength range of 200 nm to 400 nm such as diazo compounds, photoacids, photoinitiators, quinone diazides, or sensitizers. Preferably the coating neither contains compounds which have an absorption maximum in the blue and green visible light wavelength range between 400 and 600 nm.

According to a preferred embodiment, the material of the present invention is image-wise exposed to infrared light, which is converted into heat by an infrared light absorbing agent, which may be a dye or pigment having an absorption maximum in the infrared wavelength range. The concentration of the sensitizing dye or pigment in the coating is typically between 0.25 and 10.0 wt. %, more preferably between 0.5 and 7.5 wt. % relative to the coating as a whole. Preferred IR-absorbing compounds are dyes such as cyanine or merocyanine dyes or pigments such as carbon black. A suitable compound is the following infrared dye 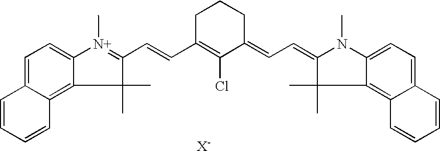
wherein X⁻ is a suitable counter ion such as tosylate.

The coating may further contain an organic dye which absorbs visible light so that a perceptible image is obtained upon image-wise exposure and subsequent development. Such a dye is often called contrast dye or indicator dye. Preferably, the dye has a blue color and an absorption maximum in the wavelength range between 600 nm and 750 nm. Although the dye absorbs visible light, it preferably does not sensitize the printing plate precursor, i.e. the coating does not become more soluble in the developer upon exposure to visible light. Suitable examples of such a contrast dye are the quaternized triarylmethane dyes. Another suitable compound is the following dye:

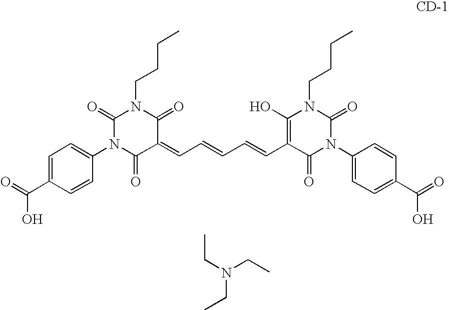

The infrared light absorbing compound and the contrast dye may be present in the layer comprising the hydrophobic polymer, and/or in the barrier layer discussed above and/or in an optional other layer. According to a highly preferred embodiment, the infrared light absorbing compound is concentrated in or near the barrier layer, e.g. in an intermediate layer between the layer comprising is the hydrophobic polymer and the barrier layer.

The printing plate precursor of the present invention can be exposed to infrared light with LEDs or a laser. Preferably, a laser emitting near infrared light having a wavelength in the range from about 750 to about 1500 nm is used, such as a semiconductor laser diode, a Nd:YAG or a Nd:YLF laser. The required laser power depends on the sensitivity of the image-recording layer, the pixel dwell time of the laser beam, which is determined by the spot diameter (typical value of modern plate-setters at 1/e² of maximum intensity: 10-25 μm), the scan speed and the resolution of the exposure apparatus (i.e. the number of addressable pixels per unit of linear distance, often expressed in dots per inch or dpi; typical value: 1000-4000 dpi).

Two types of laser-exposure apparatuses are commonly used: internal (ITD) and external drum (XTD) plate-setters. ITD plate-setters for thermal plates are typically characterized by a very high scan speed up to 1500 m/sec and may require a laser power of several Watts. The Agfa Galileo T is a typical example of a plate-setter using the ITD-technology. XTD plate-setters operate at a lower scan speed typically from 0.1 m/sec to 10 m/sec and have a typical laser-output-power per beam from 20 mW up to 500 mW. The Creo Trendsetter plate-setter family and the Agfa Excalibur plate-setter family both make use of the XTD-technology.

The known plate-setters can be used as an off-press exposure apparatus, which offers the benefit of reduced press down-time. XTD plate-setter configurations can also be used for on-press exposure, offering the benefit of immediate registration in a multi-color press. More technical details of on-press exposure apparatuses are described in e.g. U.S. Pat. No. 5,174,205 and U.S. Pat. No. 5,163,368.

In the development step, the non-image areas of the coating can be removed by immersion in an aqueous alkaline developer, which may be combined with mechanical rubbing, e.g. by a rotating brush. The developer preferably has a pH above 10, more preferably above 12. The development step may be followed by a rinsing step, a gumming step, a drying step and/or a post-baking step.

The printing plate thus obtained can be used for conventional, so-called wet offset printing, in which ink and an aqueous dampening liquid is supplied to the plate. Another suitable printing method uses so-called single-fluid ink without a dampening liquid. Single-fluid ink consists of an ink phase, also called the hydrophobic or oleophilic phase, and a polar phase which replaces the aqueous dampening liquid that is used in conventional wet offset printing. Suitable examples of single-fluid inks have been described in U.S. Pat. No. 4,045,232; U.S. Pat. No. 4,981,517 and U.S. Pat. No. 6,140,392. In a most preferred embodiment, the single-fluid ink comprises an ink phase and a polyol phase as described in WO 00/32705.

### EXAMPLES

Preparation of the Lithographic Substrate:

A 0.30 mm thick aluminum foil was degreased by immersing the foil in an aqueous solution containing 40 g/l of sodium hydroxide at 60° C. for 8 seconds and rinsed with demineralized water for 2 seconds. The foil was then electrochemically grained during 15 seconds using an alternating current in an aqueous solution containing 12 g/l of hydrochloric acid and 38 g/l of aluminum sulfate (18-hydrate) at a temperature of 33° C. and a current density of 130 A/dm². After rinsing with demineralized water for 2 seconds, the aluminum foil was then desmutted by etching with an aqueous solution containing 155 g/l of sulfuric acid at 70° C. for 4 seconds and rinsed with demineralized water at 25° C. for 2 seconds. The foil was subsequently subjected to anodic oxidation during 13 seconds in an aqueous solution containing 155 g/l of sulfuric acid at a temperature of 45° C. and a current density of 22 A/dm², then washed with demineralized water for 2 seconds and post-treated for 10 seconds with a solution containing 4 g/l of polyvinylphosphonic acid at 40° C., rinsed with demineralized water at 20° C. during 2 seconds and dried.

The support thus obtained was characterized by a surface roughness Ra of 0.50 μm and an anodic weight of 2.9 g/m of Al₂O₃.
Monomer-01 has the following structure: 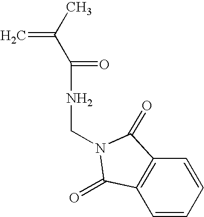
Monomer-02 has the following structure:

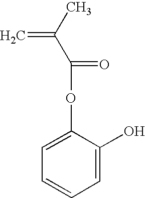

Synthesis of Polymer-01:

Polymer-01 is a copolymer of N-vinylcaprolactam, Monomer-01 and methacrylic acid in a molar ratio of 33/57/10. Polymer-Ol is prepared by the following method:

9.48 g (0.0681 mol) of N-vinylcaprolactam, 28.74 g (0.118 mol) of Monomer-01 and 1.78 g (0.0206 mol) of methacrylic acid were added to a closed reaction vessel fitted with a water-cooled condenser, thermometer, nitrogen inlet and mechanical stirrer, containing 129.6 g of γ-butyrolactone. The obtained mixture was stirred under heating at 90° C. till it became a clear solution.

1.52 g of azo-initator dimethyl-2,2′-azobisisobutyrate (V601 supplied by Wako Pure Chemical Industries, Ltd) was dissolved in 28.9 g of γ-butyrolactone. The obtained solution was added dropwise to the reaction mixture for 30 minutes. After this the reaction was continued at 90° C. for additional 7 hours. After completion of the reaction, the temperature was adjusted to room-temperature. The resulting polymer solution has a concentration of approximately 20%.

Synthesis of Polymer-02:

Polymer-02 is a copolymer of Monomer-01 and Monomer-02 in a molar ratio of 57/43. Polymer-02 is prepared by the following method:

23.33 g (0.096 mol) of Monomer-Ol and 12.84 g (0.072 mol) of Monomer-02 were added to a closed reaction vessel fitted with a water-cooled condenser, thermometer, nitrogen inlet and mechanical stirrer, containing 116.35 g of γ-butyrolactone. The obtained mixture was stirred under heating at 90° C. till it became a clear solution. 1.37 g of azo-initiator dimethyl-2,2′-azobisisobutyrate (V601 supplied by Wako Pure Chemical Industries, Ltd) was dissolved in 26.1 g of γ-butyrolactone. The obtained solution was added dropwise to the reaction mixture for 30 minutes. After this the reaction was continued at 90° C. for additional 7 hours. After completion of the reaction, the temperature was adjusted to room-temperature. The resulting polymer solution has a concentration of approximately 20%.

Synthesis of Polymer-03:

Polymer-03 is a copolymer of N-vinylcaprolactam, Monomer-01, Monomer-02 and methacrylic acid in a molar ratio of 9/57/19/15. Polymer-03 is prepared by the following method:

3.16 g (0.0227 mol) of N-vinylcaprolactam, 35.07 g (0.1436 mol) of Monomer-01, 8.53 g (0.0479 mol) of Monomer-02 and 3.25 g (0.0378 mol) of methacrylic acid were added to a closed reaction vessel fitted with a water-cooled condenser, thermometer, nitrogen inlet and mechanical stirrer, containing 162 g of γ-butyrolactone. The obtained mixture was stirred under heating at 90° C. till it became a clear solution.

1.9 g of azo-initiator dimethyl-2,2′-azobisisobutyrate (V601 supplied by Wako Pure Chemical Industries, Ltd) was dissolved in 36.1 g of γ-butyrolactone. The obtained solution was added dropwise to the reaction mixture for 30 minutes. After this the reaction was continued at 90° C. for additional 7 hours. After completion of the reaction, the temperature was adjusted to room-temperature. The resulting polymer solution has a concentration of approximately 20%.

Preparation of the Printing Plate Precursors PPP-01 to PPP-03:

The printing plate precursors PPP-01 to PPP-03 were produced by applying the coating defined in Table 1 onto the above described lithographic support. The solvent used to apply the coating is a mixture of 50% methylethyl ketone (MEK)/50% Dowanol PM (1-methoxy-2-propanol from Dow Chemical Company). The coating was applied at a wet coating thickness of 26 μm and then dried at 135° C. The dry coating weight was 1.28 g/m².

TABLE 1
Composition of the coating (g/m²)

| | PPP-01 | PPP-02 | PPP-03 |
|---|---|---|---|
| INGREDIENTS | (g/m²) | (g/m²) | (g/m²) |
| Polymer-01 | 1.080 | | |
| Polymer-02 | | 1.080 | |
| Alnovol SP452 (1) | | | 1.080 |
| 3,4,5-trimethoxy cinnamic acid | 0.1395 | 0.1395 | 0.1395 |
| SOO94 IR-1 (2) | 0.0550 | 0.0550 | 0.0550 |
| Basonyl blue 640 (3) | 0.0138 | 0.0138 | 0.0138 |
| Tegoglide 410 (4) | 0.0055 | 0.0055 | 0.0055 |
| Tegowet 265 (5) | 0.0022 | 0.0022 | 0.0022 |
| Dry thickness (g/m²) | 1.28 | 1.28 | 1.28 |

(1) Alnovol SPN452 is a 40.5 weight % solution of novolac in
Dowanol PM, commercially available from Clariant
(2) SOO94 is an IR absorbing cyanine dye, commercially available
from FEW CHEMICALS; the chemical structure of SOO94 is equal to
IR-1

| | |
|---|---|
| | IR-1 |
| 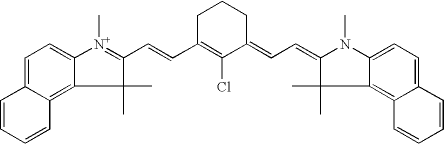 | |
| 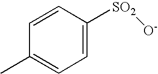 | |

(3) Basonyl blue 640 is a quaternised triaryl methane dye,
commercially available from BASF
(4) Tegoglide 410 is a copolymer of polysiloxane and polyalkylene
oxide, commercially available from Tego Chemie Service GmbH
(5) Tegowet 265 is a copolymer of polysiloxane and polyalkylene
oxide, commercially available from Tego Chemie Service GmbH

Chemical Resistance

For measuring the chemical resistance 3 different solutions were selected:
Test solution 1: solution of isopropanol in a concentration of 50% by weight in water,
Test solution 2: EMERALD PREMIUM MXEH, commercially available from ANCHOR,
Test solution 3: ANCHOR AQUA AYDE, commercially available from ANCHOR.

The chemical resistance was tested by contacting a droplet of 40 μl of a test solution on different spots of the coating. After 3 minutes, the droplet was removed from the coating with a cotton pad. The attack on the coating due to each test solution was rated by visual inspection as follows:
0: no attack,
1: changed gloss of the coating's surface,
2: small attack of the coating (thickness is decreased),
3: heavy attack of the coating,
4: completely dissolved coating.

The higher the rating, the less is the chemical resistance of the coating. The results for the test solutions on each printing plate precursor are summarized in Table 2.

TABLE 2
Test results for the chemical resistance

| EXAMPLES | | Test | Test | Test |
|---|---|---|---|---|
| number | Type PPP | solution 1 | solution 2 | solution 3 |
| Invention | PPP-01 | 2 | 2 | 1 |
| Example 1 | | | | |
| Comparative | PPP-02 | 1 | 2 | 1 |
| Example 1 | | | | |
| Comparative | PPP-03 | 3 | 4 | 3 |
| Example 2 | | | | |

The test results of Table 2 demonstrate that the precursor PPP-01 show an improved chemical resistance compared with novolac in the PPP-03. The chemical resistance of precursor PPP-02 is also improved but the differentiation between the exposed and non-exposed areas is insufficient as indicated below.

Image-Wise Exposure and Developing

The printing plate precursors were exposed with a Creo Trendsetter 3244 (plate-setter, trademark from Creo, Burnaby, Canada), operating at 150 rpm and varying energy densities up to 200 mJ/cm² and processed at 25° C. with the Agfa TD6000A developer, commercially available from Agfa-Gevaert.

The printing plate, obtained from PPP-01, exhibits a good differentiation between the exposed and non-exposed areas whereby the exposed areas are removed by the developer while the non-exposed areas are substantially not affected by the developer solution (positive-working printing plates). In the printing plate, obtained from PPP-02, the coating is only partially removed in the exposed areas, resulting in an insufficient differentiation between the exposed and non-exposed areas.

Preparation of the Printing Plate Precursor PPP-04:

The printing plate precursor PPP-04 was produced by applying the coating defined in Table 3 onto the above described lithographic support. The solvent used to apply the coating is a mixture of 50% methylethyl ketone (MEK)/50% Dowanol PM (1-methoxy-2-propanol from Dow Chemical Company). The coating was applied at a wet coating thickness of 16 μm and then dried at 135° C. The dry coating weight was 0.72 g/m².

TABLE 3
Composition of the coating (g/m²)

| | PPP-04 |
|---|---|
| INGREDIENTS | (g/m²) |
| Polymer-03 | 0.6327 |
| 3,4,5-trimethoxy cinnamic acid | 0.0409 |
| SOO94 IR-1(2) | 0.0323 |
| Basonyl blue 640(3) | 0.0081 |
| Tegoglide 410(4) | 0.0013 |
| Tegowet 265(5) | 0.0032 |
| Dry thickness (g/m²) | 0.72 |

(1) to (5): see Table 1

Chemical Resistance

The chemical resistance was determined in an analogous way as described above. The test results are summarized in Table 4.

TABLE 4
Test results for the chemical resistance

| EXAMPLE | | Test | Test | Test |
|---|---|---|---|---|
| number | Type PPP | solution 1 | solution 2 | solution 3 |
| Invention | PPP-04 | 0 | 1 | 0 |
| Example 2 | | | | |

The test results of Table 4 demonstrate that the precursor PPP-04 shows a high chemical resistance.

Image-Wise Exposure and Developing

The printing plate precursor PPP-04 was exposed and processed as described above. The printing plate, obtained from PPP-04, exhibit a good differentiation between the exposed and non-exposed areas whereby the exposed areas are removed by the developer while the non-exposed areas are substantially not affected by the developer solution (positive-working printing plates).

1. A positive-working heat-sensitive lithographic printing plate precursor comprising
a support having a hydrophilic surface or which is provided with a hydrophilic layer, and
a coating which does not dissolve in an aqueous alkaline developer in the unexposed areas and which becomes soluble in an aqueous alkaline developer in the exposed areas, wherein said coating comprises a polymer having a first monomeric unit of formula I 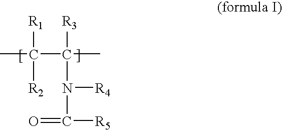
wherein
R₁, R₂ and R₃ are independently a hydrogen atom or an optionally substituted alkyl group,
R₄ and R₅ are independently an optionally substituted alkyl, cycloalkyl, aryl or arylalkyl group, or wherein R₄ and R₅ together form a cyclic structure, and
wherein said polymer comprises said first monomeric unit in an amount between 3 mol % and 75 mol %.

2. The precursor according to claim 1, wherein R₄ and R₅ together form a cyclic structure comprising at least 5 carbon atoms.

3. The precursor according to claim 1, wherein said first monomeric unit is vinylcaprolactam.

4. The precursor according to claim 1, wherein said polymer comprises said first monomeric unit in an amount between 4 mol % and 60 mol %.

5. The precursor according to claim 1, wherein said polymer further comprises a second monomeric unit of formula II: 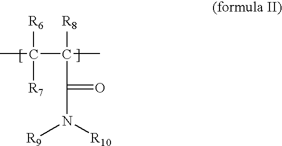
wherein
R₆, R₇ and R₈ are independently a hydrogen atom or an optionally substituted alkyl group,
R₉ is a hydrogen atom, or an optionally substituted alkyl, cycloalkyl, aryl or arylalkyl group,
R₁₀ is represented by formula III or IV: 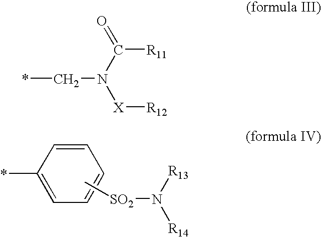
wherein
* denotes the position of attachment of the group R₁₀ to the nitrogen atom in formula II, X is —C(═O)— or —SO₂—,
R₁₁ and R₁₂ are independently an optionally substituted alkyl, alkenyl, cycloalkyl, aryl, arylalkyl or heteroaryl group, or wherein R₁₁ and R₁₂ together form a cyclic structure, and
R₁₃ and R₁₄ are independently a hydrogen atom or an optionally substituted-alkyl, alkenyl, cycloalkyl, aryl, arylalkyl or heteroaryl group, or wherein R₁₃ and R₁₄ together form a cyclic structure.

6. The precursor according to claim 5, wherein R₁₀ is represented by formula V: 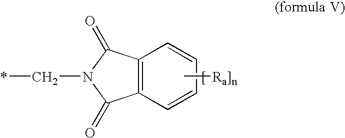
wherein
* denotes the position of attachment of the group R₁₀ to the nitrogen atom in formula II, n is 0, 1, 2, 3 or 4,
each Rₐ is independently selected from hydrogen, halogen, —CN, —NO₂, an optionally substituted alkyl, alkenyl, alkynyl, cycloalkyl, heterocyclic, aryl, heteroaryl, aralkyl or heteroaralkyl group, —O—R_{b}, —S—R_{c}, —SO₃—R_{d}, —CO—O—Rₑ, —O—CO—R_{f}, —NR_{g}Rₕ, —NRᵢ—CO—Rⱼ, —NRₖ—SO₂—Rₗ, —CO—Rₘ, —CO—NRₙRₒ, —SO₂—NRₚR_{q} or —P(═O)(—O—Rᵣ)(—O—Rₛ), wherein R_{b} to Rₛ are independently selected from hydrogen or an optionally substituted alkyl or aryl group.

7. The precursor according to claim 5, wherein said polymer comprises said second monomeric unit in an amount between 5 mol % and 95 mol %.

8. The precursor according to claim 1, wherein said polymer further comprises a third monomeric unit of formula VI: 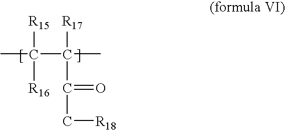
wherein
R₁₅, R₁₆ and R₁₇ are independently a hydrogen atom or an optionally substituted alkyl group, and
R₁₈ is a hydrogen atom, a positive charged metal ion or ammonium ion, or an optionally substituted alkyl, cycloalkyl, aryl or arylalkyl group.

9. The precursor according to claim 8, wherein said polymer comprises said third monomeric unit in an amount between 2 mol % and 70 mol %.

10. A method of making a positive-working heat-sensitive lithographic printing plate comprising the steps of
(i) providing a positive-working lithographic printing plate precursor as defined in claim 1,
(ii) image-wise exposing the precursor to IR-radiation or heat, and
(iii) developing the image-wise exposed precursor with an aqueous alkaline developing solution thereby removing the coating on the exposed areas while essentially not affecting the coating in the non-exposed areas by the developer.

11. The precursor according to claim 6, wherein said polymer comprises said second monomeric unit in an amount between 5 mol % and 95 mol %.
